(19) United States
(12) Patent Application Publication
(10) Pub. No.: US 2020/0327563 A1
(43) Pub. Date: Oct. 15, 2020

(54) ADAPTIVE HEAD-TO-HEAD RANKING TO REDUCE SAMPLE SIZE AND IMPROVE DATA QUALITY

(71) Applicant: SURVEYMONKEY INC., San Mateo, CA (US)

(72) Inventors: Kuang Tsung Chen, Los Altos, CA (US); Reuben Lewis Knowles McCreanor, San Francisco, CA (US); Gilad Amitai, Belmont, CA (US)

(21) Appl. No.: 16/379,375

(22) Filed: Apr. 9, 2019

(51) Int. Cl. G06Q 30/02; G06F 17/18; G06F 17/11; G06F 3/0482

(52) U.S. Cl. CPC G06Q 30/0203; G06F 3/0482; G06F 17/11; G06F 17/18

(57) ABSTRACT

A computer-implemented method of gathering data includes defining a list of items to be ranked, identifying a pivot item within the list, collecting data from users providing head-to-head comparisons between other items in the list to be ranked to the pivot item, producing a greater-than-pivot list and a lesser-than-pivot list as next lists, placing the pivot item in a final position in the list, and using the greater-than-pivot list and lesser-than-pivot list separately as the next lists of items to be ranked, repeating the identifying, collecting and placing until all items in the list are in final positions.

### BACKGROUND

Surveys provide a means for gathering information from respondents from the general population or from targeted groups. They allow the survey provider to gather all kinds of data about general topics, or specific topics like customer service questions, employee surveys, satisfaction surveys, etc.

Collecting data from online surveys offers several advantages. The surveys can reach a relatively large audience compared to written surveys, allows particular populations to be identified and queried, like attendees at a conference or event, and the responses come in as soon as the respondent finishes entering them. The data then becomes available for analysis much more quickly.

However, even with the speed of online surveys, some types of questions take a disproportional amount of time, both just to get the question answered, and then to gather a sufficient number of responses for each question to have statistical significance. For example, a question trying to gather data about a list of selections, such as “rank the following items in order of preference,” requires a nearly impossible number of responses to have statistical significance with a decent confidence interval. For example, one simulation indicated that in order to have 95% confidence on a ranking of 15 items would require 9,220 responses.

One solution is to lower the confidence ranking, which reduces the required number of samples or responses. This may reduce the statistical significance to detect differences between closely ranked items, resulting in statistically undifferentiated items, and the confidence is lowered for the entire list.

In addition, as the number of items to rank grows, it becomes burdensome for the respondents to fully rank all items. Many respondents do not fully rank the items correctly. This leads to high measurement error. Also, many respondents do not complete the question, which leads to high non-response errors. Generally, this lowers data quality as well as prolonging data collection time. A better way of collected data is needed.

### SUMMARY

One embodiment comprises a computer-implemented method of gathering data that includes defining a list of items to be ranked, identifying a pivot item within the list, collecting data from users providing head-to-head comparisons between other items in the list to be ranked to the pivot item, producing a greater-than-pivot list and a lesser-than-pivot list as next lists, placing the pivot item in a final position in the list, and using the greater-than-pivot list and lesser-than-pivot list separately as the next lists of items to be ranked, repeating the identifying, collecting and placing until all items in the list are in final positions.

### BRIEF DESCRIPTION OF THE DRAWINGS

FIG. 1 shows a system to collect data through an on-line survey system.

FIG. 2 shows a prior art version of a ranking format.

FIG. 3 shows an embodiment of a ranking format.

FIG. 4 shows a flowchart of an embodiment of a method of collecting data.

FIG. 5 shows an example of an embodiment of a method of collecting data.

### DETAILED DESCRIPTION OF THE EMBODIMENTS

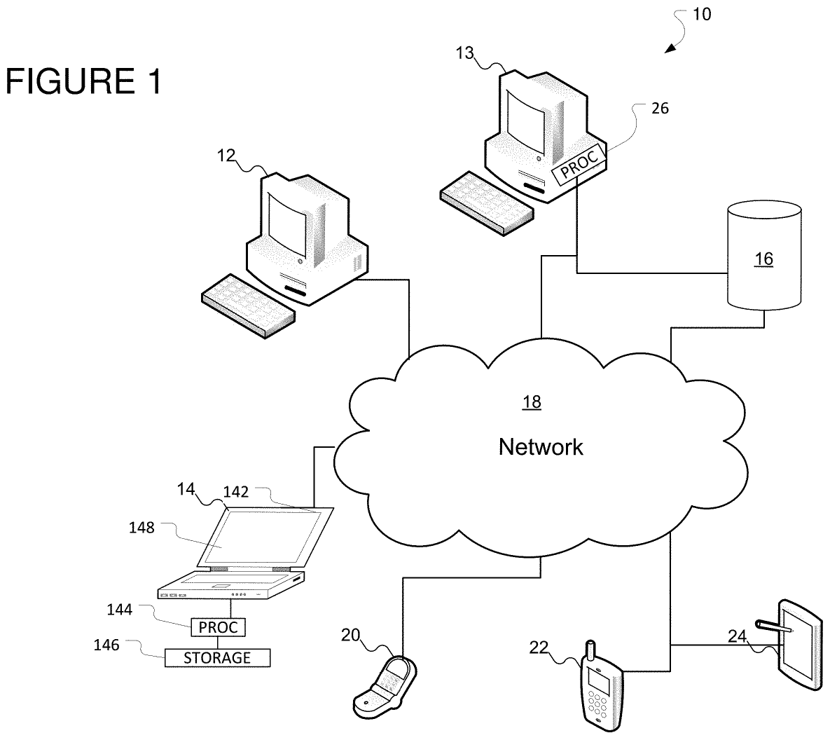

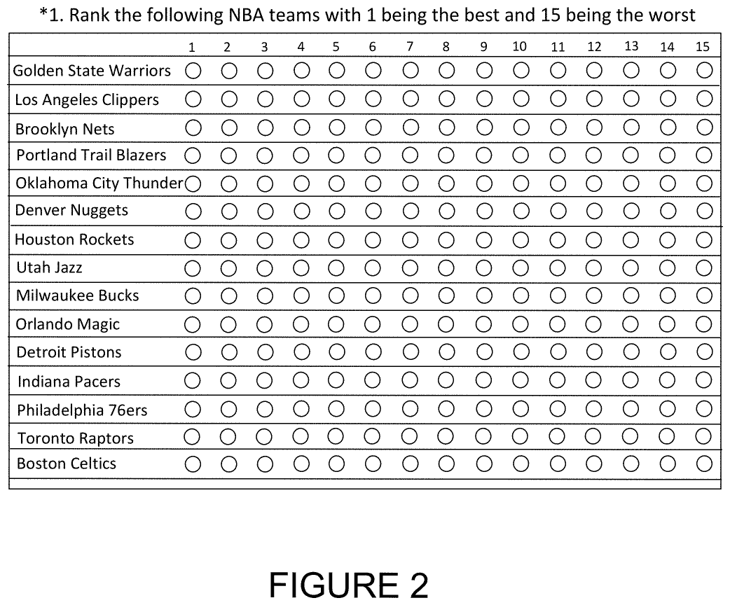

FIG. 1 shows a data collection survey system 10. In this system, the survey administrator users a computer such as 13 having a processor 26. The computer 13 has a connection, either through the network 18 or directly, to a database or other storage 16. The survey administrator develops and produces a survey having at least one list of items to be ranked, as shown in FIG. 2.

A user in the system of FIG. 1 has an electronic computing device 14 such as a smart phone, tablet, laptop, or notebook computer. The computing device 14 may include one or more processors 144 that may be configured to communicate with and are operatively coupled to some peripheral subsystems. These peripheral subsystems may include a storage subsystem/memory 146, one or more user input devices, in this embodiment a touch screen as part of the display 148, which also provides a user output interface, and a network interface, also referred to as an adapter 142.

The network interface 142 may provide an interface to other device systems and networks. The network interface 142 may serve as an interface for receiving data from and transmitting data to other systems from the computing device 14. The network interface 142 may include a wireless interface that allows the device 14 to communicate across wireless networks through a wireless access point, and may also include a cellular connection to allow the device to communicate through a cellular network. The network interface will allow the computing device 14 to communicate with one or more servers such as 12 and 13, and system data storage 16.

The device data store/memory 146 may include one or more separate memory devices. It may provide a computer-readable storage medium for storing the basic programming and data constructs that may provide the functionality of at least one embodiment of the disclosure here. The data store 146 may store the applications, which include programs, code modules, and instructions, that, when executed by one or more processors, may provide the functionality of one or more embodiments of the present disclosure. The data store 146 may comprise a memory and a file/disk storage subsystem. In addition, the computing device 14 may store data on another computer such as server 13 accessible through the network 18 via the network interface 142.

The device may also include separate control buttons, or may have integrated control buttons into the display if the display consists of a touch screen. The device in this embodiment has a touch screen and possibly one or more buttons, not shown, on the periphery of the touch screen/display 148. Alternative user input devices may include buttons, a keyboard, pointing devices such as a mouse, trackball, touch pad, etc. In general, the use of the term ‘input device’ is intended to encompass all possible types of devices and mechanisms for inputting information into the device 14.

User output devices, in this embodiment the display/touch screen 148, may include all display subsystems, audio output devices, etc. The output device may present user interfaces to facilitate user interaction with applications performing processes described here and variations.

The system of FIG. 1 gathers data from users about different topics. FIG. 2 shows typical survey question asking for a ranking of 15 NBA teams, with 1 being the best and 15 being the worst. One common scoring method is to assign a score of 15 to the best and 1 to the worst, and calculate each team's average score to produce ranks. This type of question presents two major challenges. First, some items may have very close scores, requiring an impractical sample size to differentiate those items. In order to lower the sample size, the process needs to lower the confidence level. This not only decreases statistical significance to detect differences between closely ranked items, but also lowering the statistical confidence to rank the entire list. Second, it places large cognitive burden on respondents to fully rank 15 teams, leading to high non-response rates. High non-response rates can severely hinder data collection process and introduce bias into data, as discussed in Groves, Robert M. and Peytcheva, Emilia, “The Impact of Nonresponse Rates on Nonresponse Bias: A Meta-Analysis”, Public Opinion Quarterly, vol. 72, issue 2, 2008, pp. 167-189.

Based on a simulation study, the pseudo code for which is shown under the tables, the below table shows the number of samples needed to reach a particular confidence interval to fully rank k items, given a typical statistical testing power of 0.8.

TABLE 1
Median sample size to fully rank k items under typical ranking method.

| k | 95% | 90% | 85% | 80% | 75% | 70% | 65% | 60% |
|---|---|---|---|---|---|---|---|---|
| 5 | 429 | 364 | 324 | 296 | 273 | 254 | 237 | 222 |
| 10 | 3,379 | 2,940 | 2,675 | 2,481 | 2,326 | 2,195 | 2,080 | 1,977 |
| 15 | 9,220 | 8,112 | 7,443 | 6,953 | 6,561 | 6,229 | 5,938 | 5,675 |
| 20 | 19,033 | 16,860 | 15,547 | 14,586 | 13,815 | 13,163 | 12,590 | 12,073 |
| 25 | 32,514 | 28,938 | 26,778 | 25,196 | 23,927 | 22,853 | 21,909 | 21,057 |
| 50 | 154,232 | 138,993 | 129,787 | 123,040 | 117,625 | 113,038 | 109,007 | 105,365 |
| 75 | 380,925 | 345,380 | 323,908 | 308,169 | 295,537 | 284,834 | 275,426 | 266,925 |
| 100 | 713,745 | 649,663 | 610,954 | 582,579 | 559,805 | 540,508 | 523,544 | 508,215 |

As can be seen, using traditional methods, a ranking list of 5 items requires 429 responses to attain a 95% confidence level. The increase of number of required responses for additional items in the list goes up to unmanageable numbers very quickly.

Pseudo Code

```
For number of items k = 5, 10, 15, 20, 25, 50, 75, 100:
For i from 1 to 10,000:
  Generate k random values from uniform distribution U(0, 1)
Traditional sample size:
For α value: 0.05, 0.1, 0.15, 0.2, 0.25, 0.3, 0.35, 0.4, obtain multiple-testing
  adjusted α = 1 − (1 − α)^{1/k}.
Sort k uniform values, form (k - 1) successive pairs of values.
Obtain variance, covariances for each successive pair of values based on ordered-rank
  statistics and calculate standard error for the difference between each pair of values.
Calculate sample sizes required to detect differences between successive pairs of uniform
  values for each adjusted alpha value given power of 0.8 and standard errors
  calculated from previous step.
For each alpha value, save maximum sample size among all pairs as the sample size required
  to fully rank k items in simulation i.
Obtain median of 10,000 simulation sample sizes.
Head-to-head method:
Perform quick-sort algorithm of the k uniform values, save pivot values, head-to-head
  comparison pairs, smallest value less than pivot, and largest value greater than pivot.
  For first pivot, largest value greater than pivot =1, and smallest value less than
  pivot = 0.
For each head-to-head pair, re-scale interval width to be (largest value greater than pivot) −
  (small value less than pivot).
Calculate p₁ = (uniform value 1)/(re-scaled interval width), p₂ = 1 − p1. The variables
  p₁ and p₂ represent relative strengths of uniform values given the range of values
  under current pivot range and are used as binomial distribution parameters.
  For each a value: 0.05, 0.1, 0.15, 0.2, 0.25, 0.3, 0.35, 0.4, use Worst Outcome
Criteria (WOC) to estimate sample sizes needed for beta-binomial distribution to detect
difference of (p₁ - p₂) as discussed in Lan, Cyr E., Joseph, Lawrence, and Wolfson, David B.
“Bayesian Sample Size Determination for Binomial Proportions”, Bayesian Analysis, vol. 3,
no. 2, 2008, pp. 269-296, given hyperparameters 1 and 1 (this gives us the most conservative
estimate of sample size).
If estimated sample size from previous step is greater than 500, calculate confidence-level to
  detect difference between p1 and p2 based on beta-binomial distribution, given hyper
  parameters 500 * p₁ + 1, 500 * p₂ + 1, and alpha value.
For each alpha value, take sum over all head-to-head pair sample sizes as the sample size
  needed to order k items with the head-to-head method, and average confidence levels
  for each head-to-head comparison to obtain overall confidence level in simulation i.
Obtain median of 10,000 simulation sample sizes median of 10,000 simulation samples under
  head-to-head comparisons, and corresponding median of 10,000 overall confidence
  levels.
```

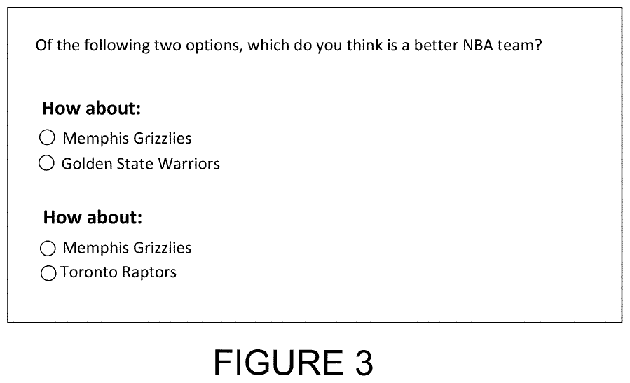

The embodiments here use a head-to-head ranking of each item in the list against the other items. FIG. 3 shows the alternative question format, in which, initially, the Memphis Grizzlies will be compared against the other teams. FIG. 3 only shows the comparison of the Memphis Grizzlies to Golden State Warriors and the Memphis Grizzlies to Toronto Raptors, but comparisons of Memphis Grizzlies to all other teams will be made.

Tables 2a-2b show statistics for various numbers of items in a list, using head-to-head rankings in an adaptive survey format, acquired from running the simulation study. When the maximum sample size was reached without detecting a winner at the target confidence level for a particular comparison, the survey was stopped and a confidence level was calculated to declare a winner for the comparison. The ‘adjusted confidence level’ is the average confidence level for all comparisons in the adaptive ranking process.

TABLE 2a
Median sample size under adaptive survey design, with maximum sample size
of head-to head set to 500. Maximum of 2 head-to-head questions are allowed per survey.

| k | 95% | 90% | 85% | 80% | 75% | 70% | 65% | 60% |
|---|---|---|---|---|---|---|---|---|
| 5 | 859 | 725 | 650 | 598 | 560 | 532 | 511 | 450 |
| 10 | 2,643 | 2,308 | 2,077 | 1,887 | 1,731 | 1,593 | 1,448 | 1,316 |
| 15 | 4,460 | 3,918 | 3,545 | 3,242 | 2,981 | 2,752 | 2,533 | 2,330 |
| 20 | 6,499 | 5,740 | 5,216 | 4,788 | 4,414 | 4,075 | 3,767 | 3,472 |
| 25 | 8,421 | 7,444 | 6,762 | 6,211 | 5,744 | 5,316 | 4,923 | 4,541 |
| 50 | 18,976 | 16,894 | 15,421 | 14,224 | 13,198 | 12,261 | 11,399 | 10,560 |
| 75 | 29,737 | 26,503 | 24,191 | 22,364 | 20,755 | 19,308 | 17,940 | 16,635 |
| 100 | 41,255 | 36,803 | 33,665 | 31,104 | 28,879 | 26,857 | 24,974 | 23,163 |

TABLE 2b
Achieved Confidence-level under adaptive survey design, with maximum sample
size of head-to-head set to 500.

| k | 95% | 90% | 85% | 80% | 75% | 70% | 65% | 60% |
|---|---|---|---|---|---|---|---|---|
| 5 | 93.6% | 89.4% | 85.0% | 80.0% | 75.0% | 70.0% | 65.0% | 60.0% |
| 10 | 92.8% | 88.4% | 83.9% | 79.3% | 74.7% | 70.0% | 65.0% | 60.0% |
| 15 | 92.7% | 88.3% | 83.8% | 79.3% | 74.6% | 69.9% | 65.0% | 60.0% |
| 20 | 92.6% | 88.3% | 83.8% | 79.2% | 74.6% | 69.9% | 65.0% | 60.0% |
| 25 | 92.6% | 88.3% | 83.8% | 79.2% | 74.6% | 69.9% | 65.0% | 60.0% |
| 50 | 92.6% | 88.2% | 83.7% | 79.2% | 74.6% | 69.9% | 65.0% | 60.0% |
| 75 | 92.6% | 88.2% | 83.7% | 79.2% | 74.6% | 69.9% | 65.0% | 60.0% |
| 100 | 92.5% | 88.2% | 83.7% | 79.2% | 74.6% | 69.9% | 65.0% | 60.0% |

As can be seen by the above tables, even using the adjusted confidence levels in Table 2b, the head-to-head rankings reduce the number of responses needed and still achieve a confidence level at most a few percentage points away from a desired confidence interval, making the number of responses statistically significant, meaning that they have a high confidence in their representation of the responses.

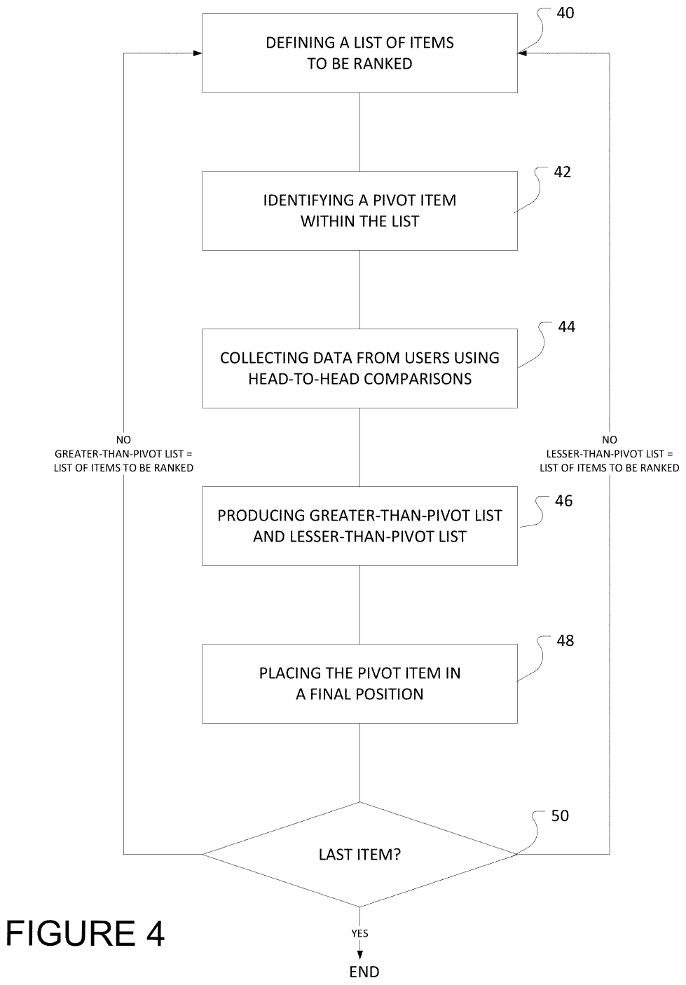

FIG. 4 shows an embodiment of a method to convert a list of items to be ranked to a series of head-to-head comparisons. The process begins with a list of items to be ranked at 40. At 42 a pivot item is chosen within the list. The initial identification of a pivot point may be done randomly, or with some previous information. For example, the items on the list may be randomly sorted and then the process may select a pivot point based upon a random selection. While there is a chance that the pivot point may reside on one end of the list of items, the chance is fairly low. In another embodiment, some previous knowledge of the items may be used to choose a pivot that the previous knowledge indicates is towards the middle of the list to bisect the list. This results in fewer comparisons to the pivot, which reduces the sample size.

Once a pivot item is selected, the process presents the user with head-to-head rankings between the pivot point and the other items on the list. Samples are collected for each ranking until a stopping point is reached at 44. The stopping point will be discussed in more detail below.

The items in the list will sort into a greater-than-pivot list and a less-than-pivot list. For example, in the head-to-head ranking shown in FIG. 3, after sufficient samples are collected from the two questions, the Golden State Warriors may be ranked lower than Memphis Grizzlies, where Memphis Grizzlies is the pivot item. The Toronto Raptors may be ranked higher than Memphis Grizzlies. Therefore, Golden State Warriors would land on the lesser-than-pivot list, and Toronto Raptors would land on the greater-than-pivot list at 46 in FIG. 4.

Once the head-to-head rankings are completed, some number of items will be greater than the pivot items, and some number will be less than the pivot item. While those new lists of greater-than-pivot and less-than-pivot still need to be ranked, the current pivot item can now be placed in its proper position.

The process then checks to see if the current item is the last item in the list at 50. The process then repeats itself using the lesser-than-pivot list and the greater-than-pivot list as the new list of items to be ranked and the process returns to 40. A new pivot item will be picked from each of these lists and it repeats until all items have been ranked.

During this process, a stopping point for collection of samples for a particular comparison could be defined. A possible stopping rule would be to stop the test when the probability of picking one element over the other is over a fixed percentage. The system may use many other stopping rules, this just serves as one example. For any given comparison, let θ be the proportion of people preferring the pivot over some element of the list. The process will put a beta prior on this so that θ˜beta(a, b) with mean

$${θ}_{0} = \frac{a}{a + b} .$$

The data observed will be in the form Y˜binomial (n, θ) where n is the the number of data points observed. After observing the data, the process can update the prior so that θ|Y=y˜beta(a+y, b+n−y). The trial continues running until a stopping rule is met. The stopping rule states that when the cumulative posterior probability of θ taken at θ₀ is less than α/2, that is P ({θ|Y=y}<θ₀)<α/2, then the chosen element of the list is preferred over the pivot, and that when the cumulative posterior probability of θ taken at θ₀ is greater than 1−α/2, that is P({θ|Y=y}<θ₀)>1−α/2, then the pivot is preferred over the element of the list.

Therefore, each head-to-head ranking instance will continue to have samples gathered until there is either a winner of the comparison or if a statistically significant number of samples have been collected. Either of these will be the stopping point.

After selection of the initial pivot, where the selection may occur with prior knowledge or randomly, the next selection of the pivot may rely upon prior information. On the first pivot, if no information is known about the prior distribution of θ, the prior parameters a and b can be set to be 1, making the prior distribution uniform. The prior parameters can be interpreted as the “prior data” where a is the prior number of people saying they prefer the pivot, and b is the number of people saying they prefer the other option. For all pivots but the first, the prior runs of the data can be used to set the prior parameters. Alternatively, the subsequent pivots can be made based on random selection.

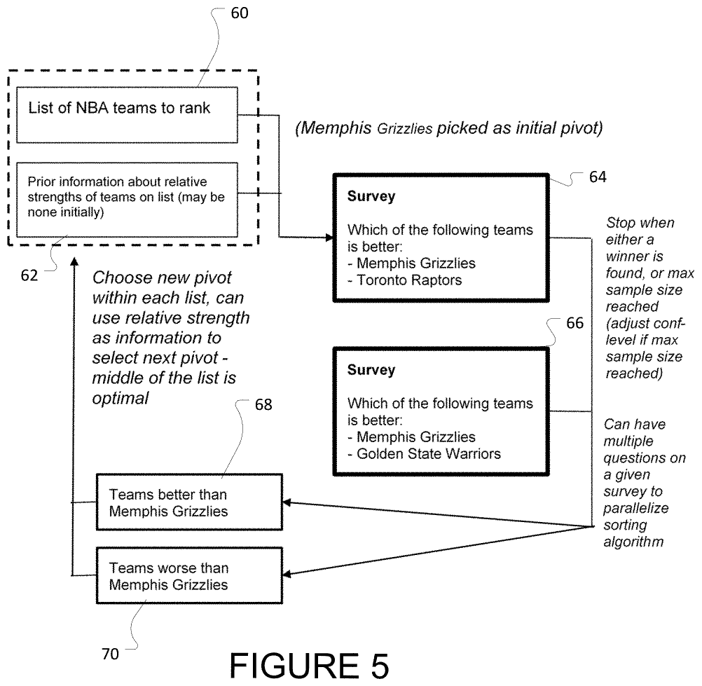

FIG. 5 shows an example of application of this data collection process. The initial list of items to be ranked consists of NBA® basketball teams at 60. There may be prior information available as part of this process as shown at 62, or none initially. The process could use a ranking of the teams' standings to pick a first pivot in the middle of the initial list.

The survey head-to-head rankings then ask the users which is the better team for each comparison. In this example, the process compares initially between the Memphis Grizzlies® or the Toronto Raptors® at 64. This comparison will continue to gather answers until there is a winner, or the maximum sample size is reached. If the maximum sample size is reached, the confidence level may be adjusted as discussed above regarding Table 2b.

Another possible modification allows a same user to answer multiple questions on a particular survey shown at 64 and 66. This type of parallelization can speed up the collection process. The number head-to-head comparisons remains unchanged, but the collection time needed to collect them can become shorter. After collecting enough samples for the comparison(s), the items in the list are ranked as either being better than the Grizzlies® at 68, or worse than the Grizzlies® at 70. The process then repeats until all of the teams are ranked in the list.

In this manner, the data collection process can maintain a confidence level and statistical significance with generally a lower number of responses. The process also reduces the burden on the users. This reduces the likelihood that users will just not rank some of the items because the user has tired of the question.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A computer-implemented method of gathering data, comprising:
defining a list of items to be ranked;
identifying a pivot item within the list;
collecting data from users providing head-to-head comparisons between other items in the list to be ranked to the pivot item;
producing a greater-than-pivot list and a lesser-than-pivot list as next lists;
placing the pivot item in a final position in the list; and
using the greater-than-pivot list and lesser-than-pivot list separately as the next lists of items to be ranked, repeating the identifying, collecting and placing until all items in the list are in final positions.

2. The computer-implemented method as claimed in claim 1, further comprising randomly ordering the list of items to be ranked prior to identifying the pivot item.

3. The computer-implemented method as claimed in claim 1, wherein identifying a pivot item within the list comprises identifying a pivot item using prior knowledge of items on the list.

4. The computer-implemented method as claimed in claim 1, wherein identifying the pivot item within the list comprises identifying a pivot item using random selection.

5. The computer-implemented method as claimed in claim 1, wherein collecting data from users comprises collecting data from users until a stopping point is reached.

6. The computer-implemented method as claimed in claim 5, wherein the stopping point comprises determination of a winner of the comparison.

7. The computer-implemented method as claimed in claim 5, wherein the stopping point comprises reaching a desired sample size.

8. The computer-implemented method as claimed in claim 7, wherein the desired sample size is based upon a confidence level.

9. The computer-implemented method as claimed in claim 1, wherein defining the list of items to be ranked comprises defining multiple lists and collecting data comprises collecting data from multiple comparisons from each user.

10. The computer-implemented method as claimed in claim 1, wherein the next lists are pre-ordered prior to identifying a new pivot in each list based upon information gathered during a previous iteration of the process.

11. The computer-implemented method as claimed in claim 1, wherein the method returns statistically significant data in a fewer number of responses than a traditional ranking method.
